(19) United States
(12) Patent Application Publication
(10) Pub. No.: US 2024/0250916 A1
(43) Pub. Date: Jul. 25, 2024

(54) MULTITENANT MANAGEMENT SYSTEM AND METHOD

(71) Applicant: Hitachi, Ltd., Tokyo (JP)

(72) Inventors: Toshiyuki ARITSUKA, Tokyo (JP); Takaki NAKAMURA, Tokyo (JP); Tatsuya HIRAI, Tokyo (JP); Tomohiro SHINOHARA, Tokyo (JP)

(21) Appl. No.: 18/238,119

(22) Filed: Aug. 25, 2023

(30) Foreign Application Priority Data
Jan. 19, 2023 (JP) 2023-006837

(51) Int. Cl. H04L 47/722; H04L 9/40

(52) U.S. Cl. CPC H04L 47/722; H04L 63/08

(57) ABSTRACT

A multitenant management system selects a name space corresponding to a user from a plurality of name spaces and determines whether the user is a legitimate user by using user management information of the name space. When a result of the determination is positive, the system determines whether a resource of an access destination conforming to the received resource access request falls within a resource access range corresponding to one tenant scope indicated by the user management information of the selected name space. When the result of the determination is positive, the system executes the resource access request.

### CROSS-REFERENCE TO RELATED APPLICATION

The present application claims priority from Japanese application JP2023-006837, filed on Jan. 19, 2023, the content of which is hereby incorporated by reference into this application.

### BACKGROUND OF THE INVENTION

### 1. Field of the Invention

The present invention generally relates to user access to resources in a system used as a multitenant.

### 2. Description of Related Art

Techniques for preventing illegal access and improving security by limiting access to resources of systems such as storage systems to access from permitted users and access for permitted operations are known. In role based access control (RBAC) which is one of access control methods, roles to which access privileges according to work are given can be allocated to users making access to resources, and whether resources can be accessed is determined based on roles allocated to the users. Accordingly, unintended access to resources such as an unanticipated resource operation or an erroneous operation can be prevented and a user management load can be reduced.

Multitenant management systems in which a plurality of different organizations or a plurality of different departments are a plurality of “tenants” are known. The “tenants” may be groups of users belonging to operations or departments which are the tenants. In multitenant management systems, resources are associated for each tenant. In multitenant management systems, to guarantee independency between tenants, it is necessary to execute access control in units of tenants in which users are managed independently for each tenant or an access privilege to specific resources is limited to tenants associated with the resources. System managers providing resources to a plurality of tenants are required to have privileges to execute specific operations such as operations of making access to resources associated with tenants and monitoring states, as necessary. It is conceivable that access privileges for resources associated in advance with arbitrary tenants are given to system managers. However, from the viewpoint of independency of tenant management or a reduction in a management load on the system managers, it is not desirable to give unnecessarily wide privileges to the system managers.

For example, as technical literatures of the related art in which techniques related to multitenant management are disclosed, there are WO2015/200379A and JP2013-8229A.

It is conceivable that a name space is allocated to each tenant, a user is managed independently for each tenant, and a role is allocated to a user belonging to the tenant. When authentication in a name space is successful, a user can make access to a resource associated with a tenant allocated to the name space. However, when a system manager is required to make access to the resource associated with each of tenants, it is necessary to authenticate the system manager with regard to a name space corresponding to a tenant according to the tenant. As such, it is necessary to execute authentication by the number of tenants, which makes management complicated.

It is conceivable that, as a method of solving such problem, a single name space is allocated to a plurality of tenants and the system manager is registered to the same name space. However, since the plurality of tenants are managed by a single name space, independency between the tenants cannot be guaranteed. For example, when User A of Tenant A has been registered earlier in a name space and there is User B that has the same name as User A, User B cannot be registered in the name space because User B has the same name as User A even though the tenant is different.

### SUMMARY OF THE INVENTION

As a representative example of the present disclosure, a multitenant management system (hereinafter referred to as a “system” in the paragraph) receives user information which is information regarding users, tenant information that is information regarding a tenant, and a resource access request for designating a resource of an access destination among a plurality of resources from a user terminal. The system selects a name space corresponding to the tenant indicated by the received tenant information. The system executes authentication determination to determine whether the received user information is appropriate for information included in user management information of the selected name space. For each of a plurality of name spaces including a name space of each tenant, the user management information includes information regarding a user associated with a tenant corresponding to the name space and information indicating a tenant scope which is a label of a resource access range for one or two or more tenants. When a result of the authentication determination is positive, the system executes authorization determination to determine whether a resource of an access destination conforming to a received resource access request falls within a resource access range specified from entire scope management information to correspond to one tenant scope indicated by the user management information of the selected name space. The entire scope management information is information indicating a resource access range corresponding to a tenant scope with regard to each of all tenant scopes. When the result of the authorization determination is positive, the system executes the received resource access request.

According to a representative example of the present invention, a user can make access to a plurality of tenants without authentication for each name space while guaranteeing independency between tenants. Other problems, configurations, and effects are clarified in the following embodiments.

### BRIEF DESCRIPTION OF THE DRAWINGS

FIG. 1 is a diagram illustrating a configuration example of a computer system according to an embodiment;

FIG. 2 is a diagram illustrating a logical configuration example of a computer system according to a comparative example;

FIG. 3 is a diagram illustrating an example of a resource access command according to the embodiment;

FIG. 4 is a diagram illustrating an example of a user management table according to the embodiment;

FIG. 5 is a diagram illustrating an example of a policy management table according to the embodiment;

FIG. 6 is a diagram illustrating an example of a scope management table according to the comparative example;

FIG. 7 is a diagram illustrating an example of multitenant management according to the comparative example;

FIG. 8 is a diagram illustrating another example of the multitenant management according to the comparative example;

FIG. 9 is a diagram illustrating a logical configuration example of a computer system according to the embodiment;

FIG. 10 is a diagram illustrating an example of an entire scope management table according to the embodiment;

FIG. 11 is a diagram illustrating an example of the user management table according to the embodiment;

FIG. 12 is a diagram illustrating a logical configuration example of a scope management unit according to the embodiment;

FIG. 13 is a diagram illustrating an example of multitenant management according to the embodiment;

FIG. 14 is a diagram illustrating a modified example of the multitenant management according to the embodiment;

FIG. 15 is a diagram illustrating an example of flows of user creation and privilege setting according to the embodiment;

FIG. 16 is a diagram illustrating an authentication and authorization flow regarding a system manager according to the embodiment;

FIG. 17 is a diagram illustrating an authentication and authorization flow regarding a Tenant 1 manager according to the embodiment;

FIG. 18 is a diagram illustrating an authentication and authorization flow regarding a Tenant 2 manager according to the embodiment;

FIG. 19 is a diagram illustrating an example of multitenant management transition according to the embodiment;

FIG. 20 is a diagram illustrating another example of the multitenant management according to the embodiment;

FIG. 21 is a diagram illustrating still another example of the multitenant management according to the embodiment;

FIG. 22 is a diagram illustrating still another example of the multitenant management according to the embodiment;

FIG. 23 is a diagram illustrating still another example of the multitenant management according to the embodiment; and

FIG. 24 is a diagram illustrating an example of a user affiliation table according to the embodiment.

### DESCRIPTION OF EMBODIMENTS

In the following description, an “interface device” may be one or more interface devices. The one or more interface devices may be at least one of the following devices.
One or more input/output (I/O) interface device. The input/output (I/O) interface device is an interface device for at least one of an I/O device and a remote display computer. The I/O interface device for the display computer may be a communication interface device. At least one I/O device may be a user interface device, for example, any of an input device such as a keyboard and a pointing device and an output device such as a display device.
One or more communication interface devices. One or more communication interface devices may be the same type of one or more communication interface devices (for example, one or more network interface cards (NICs)) or different types of one or more communication interface devices (for example, an NIC and a host bus adapter (HBA)).

In the following description, a “memory” is one or more memory devices which are examples of one or more storage devices, and may be typically a main storage device. At least one memory device in a memory may be a volatile memory device or a nonvolatile memory device.

In the following description, a “permanent storage device” may be one or more permanent storage devices which are examples of one or more storage devices. The permanent storage device may be typically a nonvolatile storage device (for example, an auxiliary storage device). Specifically, for example, the permanent storage device may be a hard disk drive (HDD), a solid state drive (SSD), a non-volatile memory express (NVME) drive, or a storage class memory (SCM).

In the following description, a “storage device” may be at least a memory of a memory and a permanent storage device.

In the following description, a “processor” may be one or more processor devices. At least one processor device may be typically a microprocessor device such as a central processing unit (CPU) or may be another type of processor device such as a graphics processing unit (GPU). At least one processor device may be a single core or multicores. At least one processor device may be a processor core. At least one processor device may be a processor device in a broad sense, such as a circuit (for example, a field-programmable gate array (FPGA), a complex programmable logic device (CPLD), or an application specific integrated circuit (ASIC)) which is a collection of gate arrays in a hardware description language executing some or all of the processes.

In the following description, a table such as a “xxx table” may be explaining information that can obtain an output by an input will be described in some cases. However, the information can be data having any structure (for example, structured data or unstructured data) or may be a learning model which is a base table for a neural network, a genetic algorithm, or a random forest generating an output by an input. Accordingly, a “xxx table” can be referred to as “xxx information”. In the following description, a configuration of each table is exemplary. One table may be divided into two or more tables, or some or all of two or more tables may be one table.

In the description, a function is described in an example of a “yyy unit”, but a function may be implemented by causing a processor to execute one or more computer programs, may be implemented by one or more hardware circuits (for example, an FPGA or an ASIC), or may be implemented by a combination thereof. When a function is implemented by causing a processor to execute a program, since a predetermined process is executed using an appropriate storage device and/or an interface device or the like, the function may be considered to be at least a part of the processor. A process described using a function as a subject may be a process executed by a processor or a device including the processor. The program may be installed from a program source. The program source may be, for example, a program distribution computer or a computer-readable recording medium (for example, a non-transitory recording medium). Description of each function is exemplary. A plurality of functions may be integrated into one function or one function may be divided into a plurality of functions.

In the following description, ID is adopted as an example of identification information for an element. The identification information may be information with which the element can be identified.

In the following description, when the same type of elements are not distinguished from each other in description, common signs are used among reference signs. When the same type of elements are distinguished from each other in description, reference signs are used in some cases.

Hereinafter, an embodiment of the present invention will be described with reference to the drawings. The following description and drawings are exemplary in description of the present invention. To clarify the description, omission and simplification are made as appropriately. The present invention can be embodied in other various forms. The number of constituents may be singular or plural unless otherwise mentioned.

Embodiments to be described below are not limited to inventions of claims. All combinations of elements described in the embodiments are not said to be essential to solutions to the inventions.

Hereinafter, multitenant management according to an embodiment of the present invention will be described.

A storage system (an example of a multitenant management system) according to the embodiment allocates different name spaces for individual tenants or system management other than the tenants, executes authentication of a tenant user or a system manager user for each name space, sets an access privilege for a specific resource type and a privilege to execute a specific operation, and executes an authorization determination process for the privileges for each name space. The storage system allows a user registered in a certain name space to designate a resource range associated with another name space and execute access and operation by managing the resource range associated with a tenant or a system without limiting the resource range to a name space. The present disclosure may be applied to resource access control for a target system different from the storage system. An access execution privilege may be given according to, for example, a role of a user or may be given using another condition item as a reference.

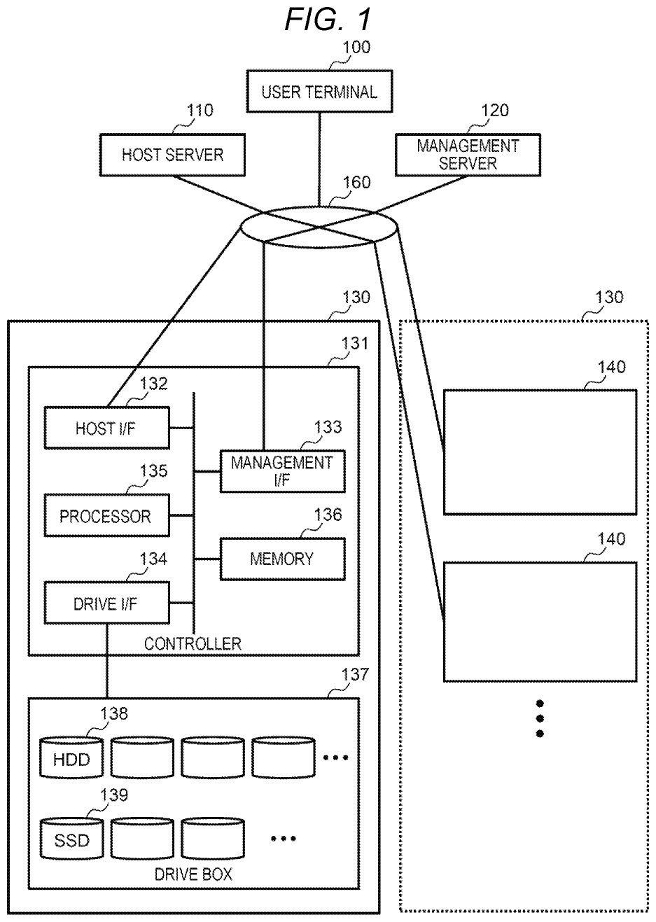

FIG. 1 illustrates a configuration example of a computer system according to the embodiment.

The computer system includes a user terminal 100, a host server 110, a management server 120, and a storage system 130. The user terminal, the host server, the management server, and the storage system can communicate via a network 160. The storage system 130 can also have a distributed configuration. For example, the storage system 130 configured with a plurality of storage nodes 140 may be adopted. The number of storage nodes is not limited and may be added or deleted as necessary. The distributed storage system can be configured using a known technology. Any number of constituents can be used. The user terminal 100 may include functions of the host server 110 and/or the management server 120.

The network 160 may be, for example, a local area network (LAN) or a storage area network (SAN). The host server 110 and the management server 120 may access the storage system 130 via a different network. The user terminal 100 may access the host server 110 or the management server 120 via a network different from the network 160.

The user terminal 100 is a device that enables access from a user to the computer system. The user terminal 100 can have, for example, a general computer configuration and includes, for example, an interface device, a storage device, and a processor connected to the interface device and the storage device. The user terminal 100 may include hardware dedicated for a specific process. The user terminal 100 may include an I/O device (for example, a keyboard and pointing and display devices).

The host server 110 is a host machine on which a user application or the like operates. The host server 110 can have, for example, a general computer configuration and includes an interface device, a storage device, and a processor connected to the interface device and the storage device. The host server 110 may include hardware dedicated for a specific process. The host server 110 can execute various software programs. The host server 110 executes, for example, a database or a web service, and writes and reads data produced by the database or the web service to and from the storage system 130 via the network 160. The host server 110 may execute a resource using application to be described below.

The management server 120 manages the storage system 130. The management server 120 can have, for example, a general computer configuration and includes an interface device, a storage device, and a processor connected to the interface device and the storage device. The management server 120 may include hardware dedicated for a specific process. The management server 120 may execute a software program that manages an authentication and authorization system to be described below.

The computer system includes the authentication and authorization system to be described below.

The storage system 130 includes a controller 131 and a drive box 137. The controller 131 includes a host interface 132, a management interface 133, a drive interface 134, a memory 136, and a processor 135 connected to the host interface 132, the management interface 133, the drive interface 134, and the memory 136. Any number of constituents can be used.

The host interface 132 is an interface device that communicates with the host server 110. The management interface 133 is an interface device that communicates with the management server 120. The drive interface 134 is an interface device that communicates with the drive box 137.

The drive box 137 houses one or more nonvolatile or volatile storage drives that store various types of data used by application programs of the host server 110. The drive box 137 is connected to the drive interface 134 of the controller 131. In the configuration example of FIG. 1, the drive box 137 includes a plurality of hard disk drives (HDDs) 138 and a plurality of solid state drives (SSDs) 139. The plurality of storage drives 138 and 139 may configure groups for data redundancy such as redundant arrays of independent disks (RAIDs).

The controller 131 controls the storage system 130. The controller 131 supplies a host server 210 with volumes that store data of the host server 210. The controller 131 allocates physical storage areas of the storage drives 138 and 139 to volumes and stores data in the storage drives 138 and 139. The controller 131 supplies the host server 110 with a function as a storage.

The processor 135 gives an instruction to transmit data stored in the corresponding drive box 137 in response to a read command or a write command from the host server 110. The memory 136 of the controller 131 is configured with, for example, a semiconductor memory such as synchronous dynamic random access memory (SDRAM). The memory may be configured by combining a volatile memory and a nonvolatile memory.

The processor 135 executes processes for control of the storage system 130 and communication with the host server 110, the management server 120, and the drive box 137. The memory 136 stores a program and various types of data for control or communication as a main storage of the processor 135. The memory 136 stores a software program implementing the authentication and authorization system to be described below. The memory 136 is also used as a disk cache program (cache memory) of the controller 131. The processor 135 implements a predetermined function executing a program that is stored in the memory 136 and includes a command code.

The plurality of controllers 131 may be mounted for redundancy. The plurality of controllers 131 perform communication via a network inside the storage system 130. The controller 131 executes duplication of write data, sharing of metadata, and the like via the network inside the storage system 130. Even when one controller 131 is blocked due to maintenance, failure, or the like, another controller 131 can continue a storage process. The storage system 130 may be configured using a general server computer or may include hardware dedicated for a specific process. As described above, for example, the constituents 130, 140, and 150 may serve as storage nodes and cooperate with each other to configure one storage system. The number of storage nodes is not limited and may be added or deleted as necessary. The distributed storage system can be configured using a known technology.

The computer system may include devices other than the above-described devices. For example, the network devices such as switches or routers may be connected between networks. The computer system may be connected to a storage service on a public cloud via an external network.

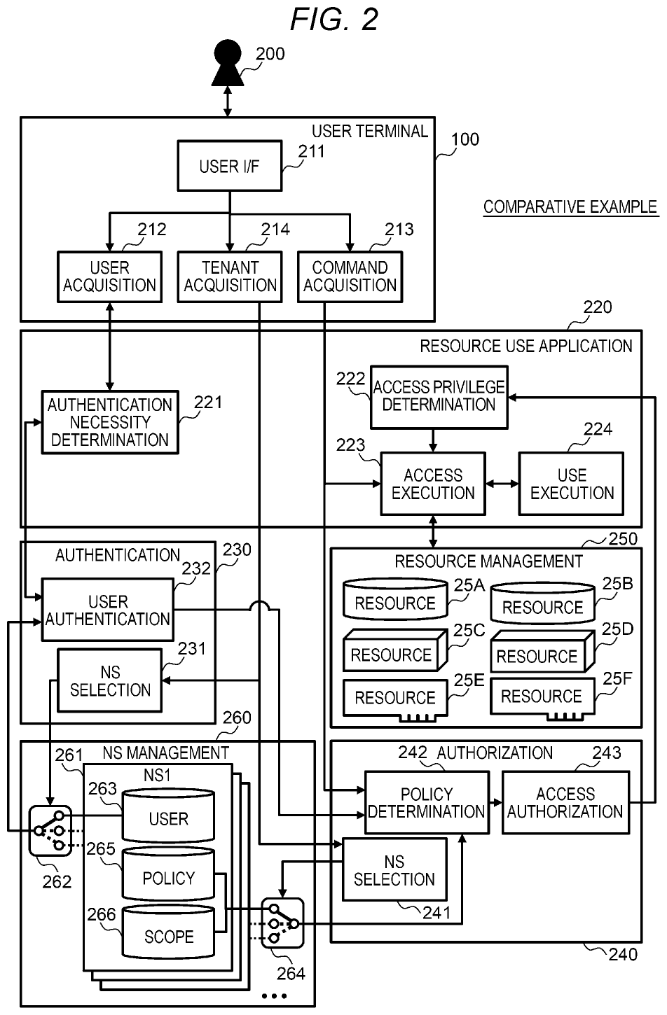

FIG. 2 illustrates a logical configuration example of a computer system according to a comparative example. In the drawing, a name space is abbreviated to “NS”.

The computer system includes a resource using application 220, an authentication platform 230, an authorization platform 240, resource management platform 250. The constituents are software constituents mounted on the computer system or functional constituents implemented by, for example, a processor.

The resource using application 220 is included in, for example, the host server 110. The authentication platform 230, the authorization platform 240, the resource management platform 250, and a name space management platform 260 are included in, for example, the storage system 130. Which function is mounted on which hardware device depends on design of the computer system. For example, a service provided as a common authentication and authorization server such as an identity as a service (IDaaS) may be used as the authentication platform 230, the authorization platform 240, and/or the name space management platform 260.

As illustrated in FIG. 2, a user 200 uses the user terminal 100 to make access to a software resource or a hardware resource of the computer system. In response to an input from the user, the user terminal 100 makes access to the resource using application 220. The user requests resource access to the resource using application 220 by issuing a command for designating a target resource, an operation on a resource, and an operation parameter via the user terminal 100.

The user terminal 100 includes a user interface (I/F) 211, a user acquisition unit 212, a command acquisition unit 213, and a tenant acquisition unit 214. The user interface 211 is a user interface used for the user 200 to make a request for executing a resource operation using the user terminal 100. For example, a web browser can be used.

The user acquisition unit 212 acquires user information such as a user name, an account name, a login ID, and a password input by the user 200. The command acquisition unit 213 acquires a resource access command input via the user interface 211 by the user and transmits the resource access command to a policy determination unit 242 of the authorization platform 240 and a resource access execution unit 223 of the resource using application 220. The tenant acquisition unit 214 acquires tenant information of a tenant such as a tenant which is input by the user 200 and to which the user belongs or a tenant associated with a resource to which access is requested by the user, and transmits the acquired tenant information to a name space selection unit 231 of the authentication platform 230 and a name space selection unit 241 of the authorization platform.

The resource using application 220 executes a process by making access to a resource such as a storage resource, a compute resource (including a bare machine, a virtual machine (VM), and a container), and a network resource. The resource using application 220 includes an authentication necessity determination unit 221, an access privilege determination unit 222, the resource access execution unit 223, and a resource use execution unit 224.

When the user 200 makes a resource access request (when the user transmits a resource access command), the authentication necessity determination unit 221 acquires information for identifying the user, for example, an account name, from the user acquisition unit 212 of the user terminal 100 and determines whether authentication is necessary or the user is already authenticated. When the authentication is necessary and the user is not authenticated, the authentication necessity determination unit 221 requests authentication from the authentication platform 230. When the user 200 is authenticated or when the authentication platform 230 notifies that the authentication is completed, the authentication necessity determination unit 221 requests the authorization platform 240 to authorize a resource access request (a resource access command).

The resource access execution unit 223 acquires the resource access command from the command acquisition unit 213 of the user terminal 100. The resource access command may be acquired by the resource access execution unit 223 after access to the resource and execution of an operation are authorized as a result of the determination by the policy determination unit 242 of the authorization platform 240.

The access privilege determination unit 222 determines whether the resource access requested by the user 200 is authorized. When the access is authorized, the access privilege determination unit 222 permits the resource access execution unit 223 to execute the resource access command.

The resource access execution unit 223 issues the resource access command to the resource management platform 250. The resource use execution unit 224 executes a predetermined process based on the resource access.

The authentication platform 230 executes user authentication when an authentication request is transmitted from the authentication necessity determination unit 221 of the resource using application 220. The authentication platform 230 includes the name space selection unit 231 and a user authentication unit 232. The name space selection unit 231 selects a name space to which a tenant is allocated based on the tenant information acquired from the tenant acquisition unit 214 of the user terminal 100. The user authentication unit 232 executes a sign-in process by the user 200. Specifically, the user authentication unit 232 authenticates that the user 200 is a user themselves registered in advance in the computer system, for example, by using a password and/or biological information such as a fingerprint or a face input via the user terminal 100 from the user 200.

The name space management platform 260 includes one or more name spaces 261 and name space selectors 262 and 264. The name space 261 includes a user management table (TBL) 263, a policy management table 265, and a scope management table 266.

When the user authentication unit 232 of the authentication platform 230 requests access to the user management table 263, the name space management platform 260 links the user management table 263 of any name space 261 selected by the name space selector 262 to the user authentication unit 232 based on a name space selected by the name space selection unit 231.

The user management table 263 stores information regarding a user registered as an authentication target, for example, a user name, a duty, an E-mail address, a password, information for comparing biological information, an affiliation group, an access date and time, an allocated role, and a scope indicating an access range of an access target resource type. A scope included in the scope management table 266 of any name space 261 is allocated to the user. The user authentication unit 232 executes user authentication by comparing the user information input when the user 200 signs in with information stored in the user management table 263 of the name space management platform 260.

When the user authentication unit 232 successfully executes the authentication, the user authentication unit 232 transmits user information including a role and a scope allocated to the user to the policy determination unit 242 of the authentication platform 240.

The user information acquired when user authentication was first executed may be retained in one or all of the resource using application 220, the authentication platform 230, and the authorization platform 240 while authentication of the target user is valid (during a valid session). When the same user issues a resource access request, a policy may be determined using the retained user information. The retained user information may be discarded together with end of a session available period.

The authorization platform 240 determines whether the user 200 authenticated in the authentication platform 230 has an access privilege to a resource to which the user 200 requests access and an operation execution privilege of the resource. When the user 200 has the access privilege and the operation execution privilege, the authorization platform 240 authorizes execution. When the user 200 does not have the access privilege or the operation execution privilege, the authorization platform 240 does not authorize the execution.

The authorization platform 240 includes the name space selection unit 241, the policy determination unit 242, and an access authorization unit 243.

The name space selection unit 241 selects a name space to which a tenant is allocated based on the tenant information acquired from the tenant acquisition unit 214 of the user terminal 100. When the policy determination unit 242 of the authorization platform 240 requests access to the policy management table 265 and the scope management table 266, the name space management platform 260 links the policy management table 265 and the scope management table 266 of any name space 261 desired to be selected by the name space selector 264 to the policy determination unit 242 based on the name space selected by the name space selection unit 241.

The policy determination unit 242 acquires user information including a role and a scope for an authenticated user from the user authentication unit 232. The policy determination unit 242 acquires information regarding a resource which is a target of a request resource access command and an operation on the resource from the command acquisition unit 213 of the user terminal 100.

The policy determination unit 242 compares the acquired information with information regarding an access policy (policy information) stored in the policy management table 265 and information regarding an access range (scope information) stored in the scope management table 266 which are associated with any name space 261 of the name space management platform 260, and determines whether the user 200 has the access privilege and the operation execution privilege in the resource range of the requested resource type.

The policy management table 265 stores policy information used by the policy determination unit 242. The policy information includes, for example, a role, a privilege given to the role, a resource to which a privilege permits access, and a determination rule with which an operation that is permitted on the resource is associated. The policy determination unit 242 determines whether a requested resource access and a privilege to execute an operation on the resource is given to the role allocated to the user 200 authenticated by the user authentication unit 232 with reference to the policy management table 265. The policy determination unit 242 determines whether the access privilege to the requested resource range is given to a scope allocated to the user 200 authenticated by the user authentication unit 232 with reference to the scope management table 266.

When the policy management unit 242 determines that the user 200 has an access privilege to the resource range of the requested resource type and an execution privilege of a requested operation, the access authorization unit 243 authorizes the access and the operation on the resource. The access authorization unit 243 transmits an authorization code to the resource using application 220.

A role and scope allocation information retained in one or all of the resource using application 220, the authentication platform 230, and the authorization platform 240 may be discarded along with the session information when the session available period ends.

In another example, when the retained user information is updated by a normal measure or the like to allocate a role and a scope to a user, the retained user information may be synchronized with the role and the scope allocation information of the user management table 263 of the authentication platform 230 at a required timing and may be used when a new session is started. Accordingly, when the same user requests new resource access after the end of the session available period, a policy can be determined based on the known role and scope allocation information.

The resource management platform 250 manages resources such as a storage resource (a volume, a pool, a file directory, or the like), a compute resource (a VM, a container, or the like), and a network resource (a domain, a port, a channel, a protocol, or the like). The resource management platform 250 includes one or a plurality of resources 25.

For example, a resource 25A is a volume of a data storage. A resource 25B is a file directory of a data storage. A resource 25C is a VM. A resource 25D is a container. A resource 25E is a domain of a network resource. A resource 25F is a port of a network resource.

FIG. 2 illustrates an example of a flow of authentication, authorization, and a resource access process according to the comparative example. An authentication and authorization protocol can be executed, for example, based on a standard such as QAuth2, OpenID Connect, or SAML. Data containing information necessary for authentication and authorization (for example, various tokens) are exchanged between the user terminal 100, the resource using application 220, the authentication platform 230, and the authorization platform 240, and thus authentication and authorization process can be executed while preserving security. As described above, the user 200 transmits a resource access command using the user terminal 100.

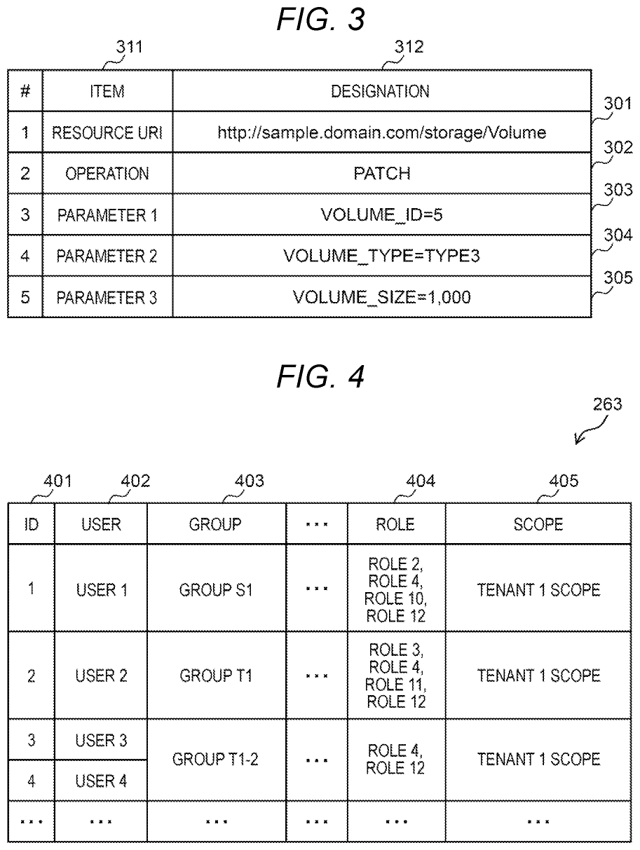

FIG. 3 illustrates an example of a resource access command issued by the command acquisition unit 213 of the user terminal 100.

The resource access command has information such as an item 311 of a command and designation 312 of each item. The item 311 indicates an item. The designation 312 indicates a specific value of an item. The resource access execution unit 223 issues such resource access command to the resource management platform 250.

The resource access command designates a target resource, an operation on the resource, parameters in the operation, and the like. For example, storage resource access can be executed using an application programming interface such as a REST API. The resource of an access target is, for example, a data storage area of the storage system such as a pool or a volume. As described above, the resource to be accessed and operated is not limited to storage resources.

A resource universal resource identifier (URI) 301 of the access target designates a resource (a volume in the example). For the resource designated with the resource URI 301, the resource access command defines an operation 302 of changing a volume capacity. Parameters designated for the operation 302 include a storage volume ID 303, a volume type 304, and a volume capacity 305. The operation 302 additionally includes volume creation, volume deletion, volume information acquisition, and the like.

In another resource access example, access to a compute resource is made to perform creation, deletion, change, or the like of a virtual machine (VM) or a docker container. In still another resource access example, access to a network resource is made to acquire information regarding a specific domain or create a specific network port.

When the user 200 requests resource access via the user terminal 100, the authentication necessity determination unit 221 in the resource using application 220 determines whether the user 200 is already authorized. When the user 200 is not yet authorized, the user authentication unit 232 of the authorization platform 230 requests user authentication.

The user authentication unit 232 executes user authentication using a single authentication type or a combination of a plurality of authentication types to determine whether the user is legitimate. As an authentication method, a known method used in various authentication systems can be used. An authentication process can be entrusted to an external authentication system.

FIG. 4 illustrates an example of the user management table 263.

The user management table 263 exemplified in FIG. 4 stores user information allocated to a name space where Tenant 1 is managed. As the user information, for example, a user name, an affiliation group, a job title, an E-mail address, a password, information for comparing biological information, an access date and time, an allocated role and scope, and the like are stored. In FIG. 4, a user ID 401, a user name 402, an affiliation group name 403, a role name 404, and a scope 405 are illustrated as examples of information included in the user information. The user ID 401 indicates a user ID. The user name 402 indicates the name of a user. The affiliation group name 403 indicates the name of a user group to which the user belongs. The role name 404 indicates the name of a role of the user belonging to the user group. The scope 405 indicates a label of a range of an access target resource.

According to the example illustrated in FIG. 4, User 1, Group S1, Role 2, Role 4, Role 10, Role 12, and a Tenant 1 scope are set for a user with ID 1. The role name 404 and the scope 405 are allocated, for example, when a user is registered in a name space where an access control target tenant is managed. For example, User 1 belongs to Group 1, and Role 2, Role 4, Role 10, Role 12, and the Tenant 1 scope are allocated. User 2 belongs to Group T1, and Role 3, Role 4, Role 11, Role 12, and the Tenant 1 scope are allocated. User 3 and User 4 belong to Group T1-2, and Role 4, Role 12, and the Tenant 1 scope are allocated.

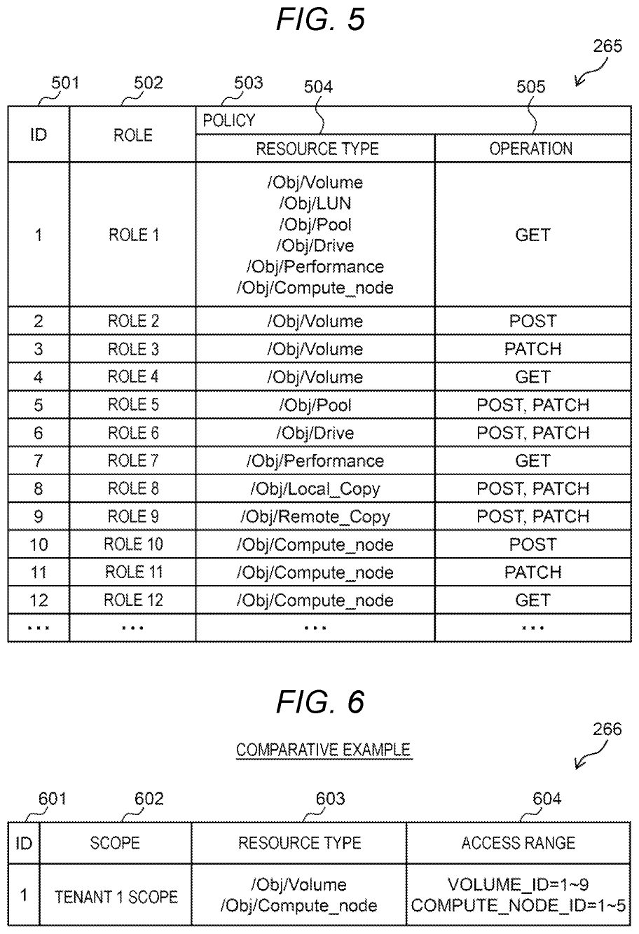

FIG. 5 illustrates an example of the policy management table 265 storing policy information.

For each role, an operation of giving an execution privilege is associated with a target resource type. Specifically, the policy management table 265 exemplified in FIG. 5 includes information such as a role ID 501, a role name 502, and a policy 503 for each role. The role ID 501 indicates an ID of the role. The role name 502 indicates a name of the role. The policy 503 includes information such as a resource type 504 associated with the role and an operation 505 on the resource.

For example, in Role 1, a volume (/Obj/Volume), LUN (/Obj/LUN), a pool (/Obj/Pool), a drive (/Obj/Drive), performance (/Obj/Performance), and a compute node (/Obj/Compute_node) are illustrated as target resource types, and information acquisition (GET) privilege is given as an operation on the target resource types.

In Role 2, a creation (POST) operation privilege is given to the volume resource type (/Obj/Volume). In Role 3, an update (PATCH) operation privilege is given to the volume resource type (/Obj/Volume). In Role 4, a reference (GET) operation privilege is given to the volume resource type (/Obj/Volume). Accordingly, for example, an information acquisition privilege for the volume, LUN, the pool, the performance, and the compute node resource type is given to a user to which Role 1 is allocated. A creation privilege for the volume resource type is given to a user to which Role 2 is allocated, and an update privilege for the volume resource type is given to a user to which Role 3 is allocated. The policy management table may be defined independently for each name space or a policy management table common to the entire system may be used.

FIG. 6 illustrates an example of the scope management table 266 according to the comparative example.

The scope management table 266 exemplified in FIG. 6 stores scope information of Tenant 1. The scope information includes, for example, information such as a scope name, a resource type, and an access range for the resource type. According to the example illustrated in FIG. 6, for example, the scope management table 266 includes information such as a scope ID 601, a scope name 602, a resource type 603, and an access range 604. The scope ID 601 indicates an ID of the scope. The scope name 602 indicates a name of the scope. The resource type 603 indicates a resource type. The access range 604 indicates a range of the resource.

According to the example illustrated in FIG. 6, a volume (/Obj/Volume) and a compute node (/Obj/Compute_node) are designated as target resource types of the Tenant 1 scope, Volume_ID=1 to 9 is allocated as an access range of the volume resource type, and Compute_node_ID=1 to 5 is allocated as an access range of a compute node resource type. Accordingly, the user to which the Tenant 1 scope is allocated can make access within the access ranges of Volume_ID=1 to 9 of the volume type and resource Compute_node_ID=1 to 5 of the compute node resource type. In the example illustrated in FIG. 4, the Tenant 1 scope is allocated to User 1. Accordingly, User 1 can make access within an access range according to a resource type defined as the Tenant 1 scope.

For example, when User 1 registered in a name space where Tenant 1 is managed also desires to access a resource of Tenant 2, user registration in which a Tenant 2 scope is allocated to the name space where Tenant 2 is managed is executed. Here, in each of the case of access to a resource associated with Tenant 1 and the case of access to a resource associated with Tenant 2, User 1 needs to execute user authentication and access authorization independently.

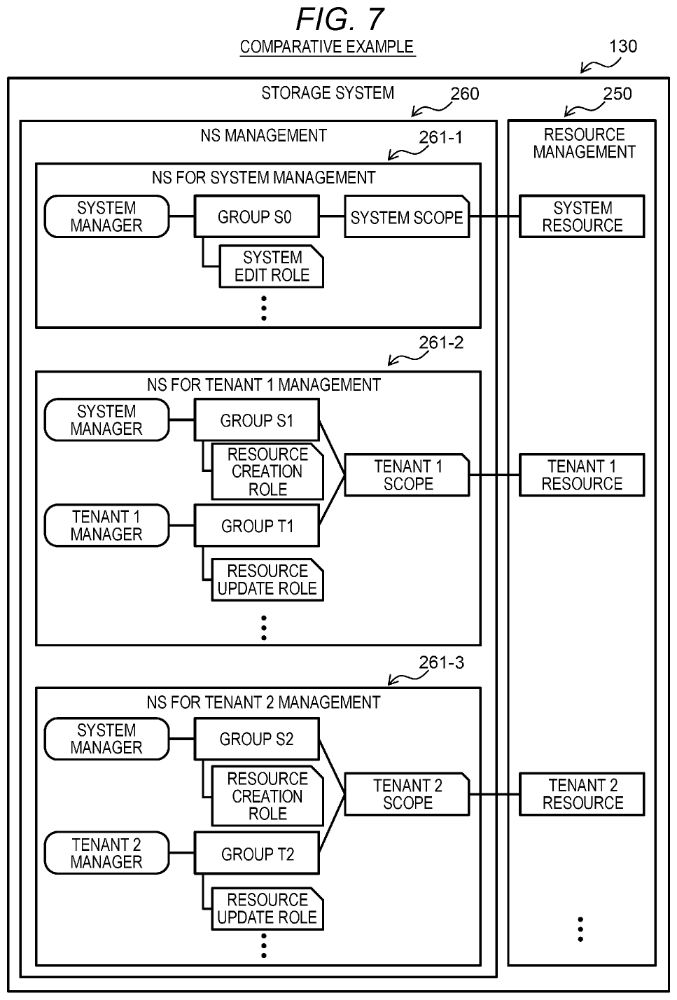

FIG. 7 illustrates an example of multitenant management according to the comparative example.

In the example illustrated in FIG. 7, a system resource except for a tenant management target is also managed using a name space for the system with the logical configuration. In a name space 261-1 for the system that is an example of the name space 261, a system manager is registered as a user and belongs to Group S0. A system edit role and a system scope are allocated to Group S0. The “system resource” is a management target resource by the system manager and includes resource of all resource types (for example, a pool, a port, a drive, a storage node, and the like) in the storage system 130. The “system edit role” is a role (for example, “Role 5”, “Role 6” exemplified in FIG. 5, or the like) that permits creation, deletion, setting change, update, or the like of a resource belonging to the system resource. The “system scope” defines the system resource as an access range. The user belonging to Group S0 has a privilege to execute an operation defined by the system edit role in the resource access range defined by the system scope. Since the system manager belongs to Group S0, the system manager can execute an operation permitted by the system edit role on the system resource.

In a name space 261-2 for Tenant 1 that is another example of the name space 261, a system manager and a Tenant 1 manager are registered as users. The system manager belongs to Group S1 and the Tenant 1 manager belongs to Group T1. A resource creation role and a Tenant 1 scope are allocated to Group S1. A resource update role and the Tenant 1 scope are allocated to Group T1. A “Tenant 1 resource” is a resource in an access range associated with Tenant 1 among resources such as a volume and a compute node. The “resource creation role” is a role that permits a creation operation (for example, “Role 2” or “Role 10” exemplified in FIG. 5) with regard to a resource belonging to the Tenant 1 resource. The “resource update role” is a role that permits an update operation (for example, “Role 3” or “Role 11” exemplified in FIG. 5) such as setting change with regard to a resource belonging to the Tenant 1 resource. The “Tenant 1 scope” defines the Tenant 1 resource as an access range. A user belonging to Group S1 has a privilege to execute an operation defined by the resource creation role with regard to the Tenant 1 resource defined by the Tenant 1 scope. A user belonging to Group T1 has a privilege to execute an operation defined by the resource update role with regard to the Tenant 1 resource defined by the Tenant 1 scope.

Since the system manager registered in the Tenant 1 name space 261-2 belongs to Group S1, the system manager can execute an operation that is permitted by the resource creation role on the Tenant 1 resource. Since the Tenant 1 manager registered in the Tenant 1 name space 261-2 belongs to Group T1, the Tenant 1 manager can execute an operation that is permitted by the resource update role on the Tenant 1 resource.

For a name space 261-3 for Tenant 2 which is still another example of the name space 261, user management similar to that of the name space 261-2 for Tenant 1 can be executed. When still another tenant is managed, a name space for another tenant is added to execute similar management. For example, when one system manager wants to execute a necessary operation on the resource access range associated with different name spaces as in the system resource, the Tenant 1 scope, and the Tenant 2 scope, since user registration and management in each name space are necessary, one user treats a plurality of pieces of account information, and thus management becomes complicated.

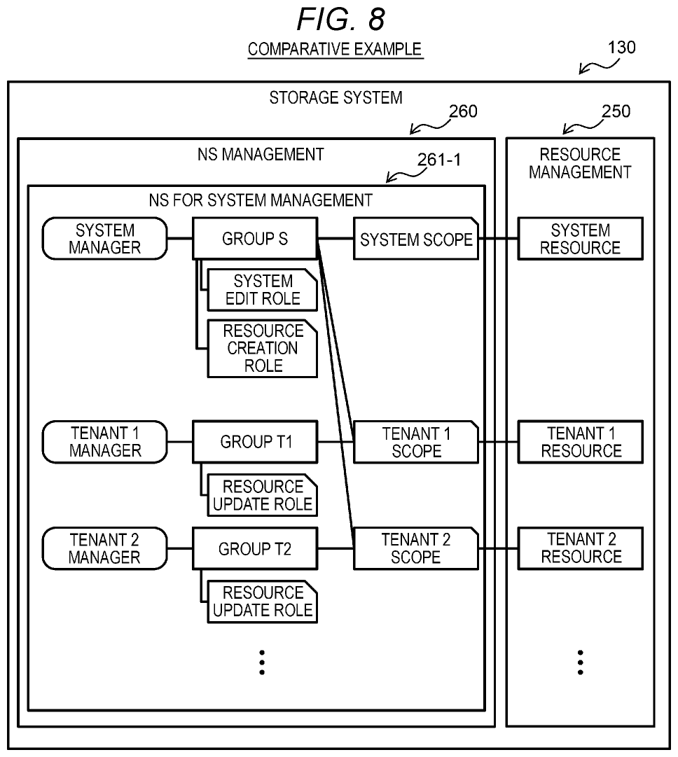

As a method of avoiding complication in authentication and authorization executed independently for each tenant, there is a method exemplified in FIG. 8.

FIG. 8 illustrates another example of the multitenant management according to the comparative example.

According to the example illustrated in FIG. 8, a plurality of tenants are managed in a single name space. For example, in the name space 261-1 for the system, a system manager, a Tenant 1 manager, and a Tenant 2 manager are registered as users. The system manager belongs to Group S, the Tenant 1 manager belongs to Group T1, and the Tenant 1 manager belongs to Group T2. A system edit role, a resource creation role, a system scope, a Tenant 1 scope, and a Tenant 2 scope are allocated to Group S. The resource update role and the Tenant 1 scope are allocated to Group T1. The resource update role and the Tenant 2 scope are allocated to Group T2. Since each of the roles, scopes, and the resource definition are similar to those of FIG. 7, description thereof will be omitted.

A user belonging to Group S has a privilege to execute an operation defined by the system edit role on the system resource defined by the system scope and has a privilege to execute an operation defined by the resource creation role on the Tenant 1 resource defined by the Tenant 1 scope and the Tenant 2 resource defined by the Tenant 2 scope. A user belonging to Group T1 has a privilege to execute an operation defined by the resource update role on the Tenant 1 resource defined by the Tenant 1 scope. A user belonging to Group T2 has a privilege to execute an operation defined by the resource update role on the Tenant 2 resource defined by the Tenant 2 scope.

Since the system manager belongs to Group S, the system manager can execute an operation defined by the system edit role on the system resource, an operation permitted by the resource creation role on the Tenant 1 resource, and an operation permitted by the resource creation role on the Tenant 2 resource. When still another tenant is managed, a tenant manager is registered to perform similar management. The user registered in the single name space as such can execute an operation and access to a plurality of tenant resources including the system resource. However, it is necessary to uniquely register a constituent defined in RBAC or the like such as a user or a group in the name space. Therefore, for example, as a user managing the same name space, a user who has a different tenant and the same user name cannot be registered. That is, independency between tenants cannot be guaranteed.

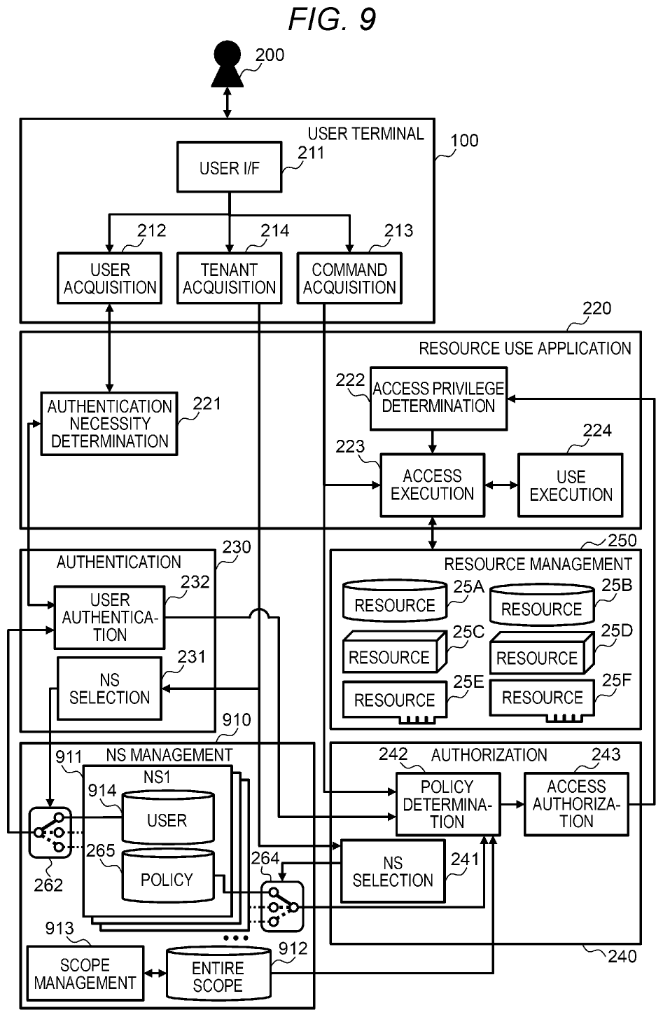

Accordingly, multitenant management (multitenant management to be described with reference to FIG. 9 and the subsequent drawings) for solving both a problem related to the multitenant management exemplified in FIG. 7 and a problem related to the multitenant management exemplified in FIG. 8 is constructed.

FIG. 9 illustrates a logical configuration example of a computer system according to the embodiment. Differences from the computer system exemplified in FIG. 2 will be mainly described with reference to FIG. 9.

A name space management platform 910 does not allocate a scope management table for each name space unlike the name space management platform 260 described in FIG. 2. Scope information is stored and managed collectively in an entire scope management table 912 in the name space management platform 910. The entire scope management table 912 is managed by a scope management unit 913. A scope to be allocated to a user corresponding to information stored in a user management table 914 is selected from the entire scope management table 912. Accordingly, a scope defining the access range of a resource associated with a tenant other than a tenant to which a user belongs can be allocated to the user. Accordingly, a user registered in a name space where the system is managed or a user registered in a name space where a specific tenant is managed can access not only a name space to which the user themselves belongs but also a name space to which the user does not belong by executing user authentication only in a name space to which the user themselves belongs and executing authentication based on user information and policy information defined in a previous space with the same name.

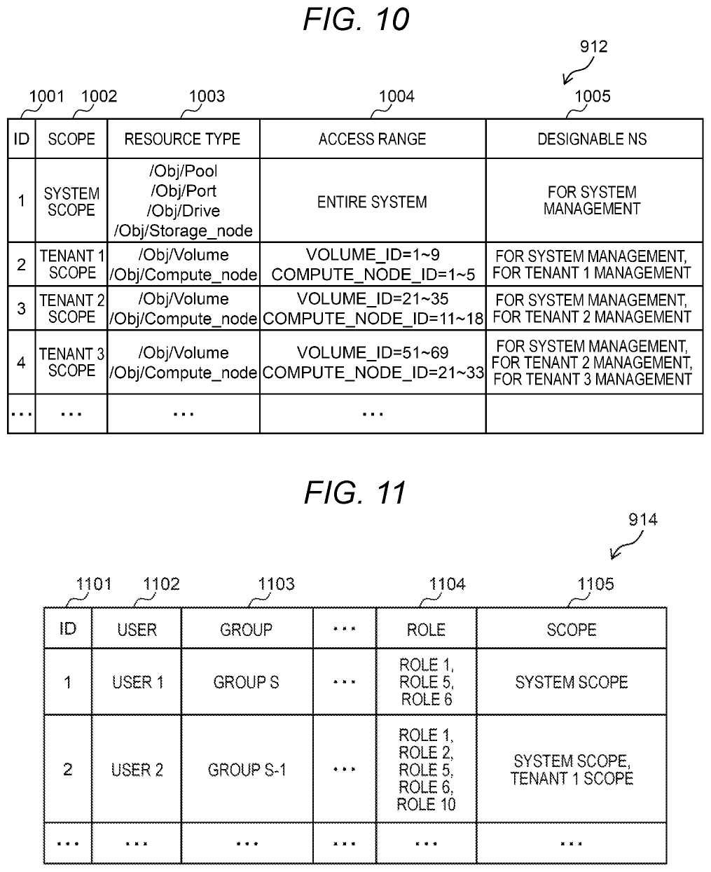

FIG. 10 illustrates an example of the entire scope management table 912.

The entire scope management table 912 stores scope information defining an access range for each resource type associated with a name space for management of a plurality of tenants. The scope information includes a scope ID 1001, a scope name 1002, a resource type 1003, and an access range 1004 for each scope which are the constituents illustrated in FIG. 6. The scope information includes a designable name space 1005 for each scope which is information regarding a name space where a scope can be designated. In the example illustrated in FIG. 10, for example, a pool (/Obj/Pool), a port (/Obj/Port), a drive (/Obj/Drive), and a storage node (/Obj/Storage_node) are designated as target resource types of the system scope, and an entire system is allocated as an access s range of each resource type. A volume (/Obj/Volume) and a compute node (/Obj/Compute_node) are designated as target resource types of the Tenant 1 scope, Volume_ID=1 to 9 is allocated as an access range of a volume resource type, and Compute_node_ID=1 to 5 is allocated as an access range of a compute node resource type. Accordingly, a user allocated to the Tenant 1 scope can make access in the access ranges of Volume_ID=1 to 9 of the volume resource type and Compute_node_ID=1 to 5 of the compute node resource type. A name space designable using the Tenant 1 scope as an access target is a name space for system management and a name space for Tenant 1 management. Similarly, a scope in which a resource range associated with a tenant accessed by the user is predetermined, such as the Tenant 2 scope or the Tenant 3 scope, is registered.

FIG. 11 illustrates an example of the user management table 914.

The user management table 914 is an example of a user management table managed in a name space for system management. The user management table 914 has, for example, a user ID 1101, a user name 1102, an affiliation group name 1103, a role name 1104, and a scope 1105 as information included in the user information as in the table 263 exemplified in FIG. 4. The pieces of information 1101 to 1105 are similar to pieces of information 401 to 405 exemplified in FIG. 4. Role 1, Role 5, Role 6, and a system scope are allocated to User 1 who is a system manager. Accordingly, User 1 can access to a system resource defined by the system scope and execute operations defined by Role 1, Role 5, and Role 6 on the system resource. Role 1, Role 2, Role 5, Role 6, Role 10, a system scope, and the Tenant 1 scope are allocated to User 2 who is another system manager. Accordingly, User 2 can execute operations defined by Role 1, Role 5, and Role 6 on the system resource defined by the system scope and operations defined by Role 2 and Role 10 on a Tenant 1 resource defined by the Tenant 1 scope.

Management of Tenant 1 is executed using the user management table 263 of the name space for the Tenant 1 management illustrated in FIG. 4. Therefore, constituents defined in RBAC such as a user and a user group of a name space for the system management can be redundantly registered. The same applies to other tenant management.

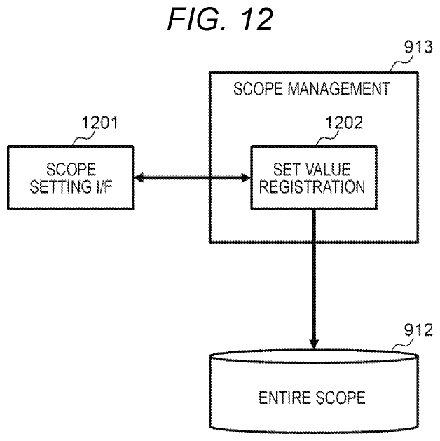

FIG. 12 illustrates a logical configuration example of the scope management unit 913.

A user such as a manager who manages the entire system sets set values of the scope information exemplified in FIG. 10 at a timing such as the time of creation of a tenant or the time of updating of tenant management information by using a scope setting interface (I/F) 1201. The scope setting I/F 1201 may be configured with dedicated software and/or hardware or may be configured as, for example, a part of a user interface function such as a graphical user interface (GUI) or a command line interface (CLI) managing the storage system such as a storage management interface. The scope information set here includes designation of a name space where a scope is permitted to be allocated as the resource access range. A scope set value registration unit 1202 of the scope management unit 913 stores a scope set value set by the user such as a system manager via the scope setting I/F 1201 in the entire scope management table 912. Here, limitation of a setting range may be imposed in advance on a set value such as a resource type, an access range, a designable name space or the like, which are referred to by a setting target scope. A function of limiting a range of a scope information set value which can be set by the user may be provided in the scope setting I/F 1201 or the scope set value registration unit 1202. The set value may be limited to a limitation range, for example, by presenting only an available set value to the user in the scope setting I/F 1201 or rejecting the setting when a set value input by the user is out of the limitation range in the scope set value registration unit 1202.

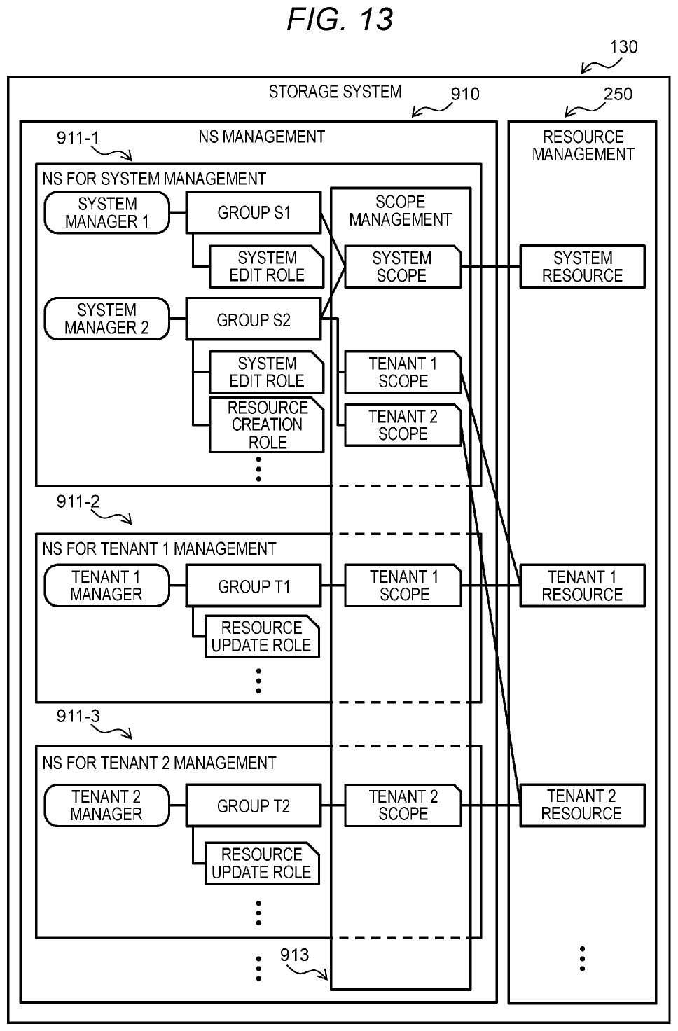

FIG. 13 illustrates an example of the multitenant management according to the embodiment.

In the example of FIG. 13, a system manager 1 is registered as a user and belongs to Group S1 in a name space 911-1 for system management which is one example of a name space 911. A system edit role and a system scope are allocated to Group S1. The user belonging to Group S1 has a privilege to execute an operation defined by the system edit role with regard to a resource access range defined by the system scope. Since the system manager 1 belongs to Group S1, the user can execute an operation permitted by the system edit role on a system resource defined by the system scope.

A system manager 2 is registered as a user and belongs to Group S2. The system edit role, a resource creation role, the system scope, the Tenant 1 scope, and the Tenant 2 scope are allocated to Group S2. The user belonging to Group S2 has a privilege to execute an operation defined by the system edit role on the system resource defined by the system scope. The user belonging to Group S2 has a privilege to execute an operation defined by the resource creation role on a Tenant 1 resource defined by the Tenant 1 scope. The user belonging to Group S2 has a privilege to execute an operation defined by the resource creation role on a Tenant 2 resource defined by the Tenant 2 scope. Since the system manager 2 belongs to Group S2, the system manager 2 can execute an operation defined by the system edit role on the system resource. The system manager 2 can execute the operations defined by the resource creation role on the Tenant 1 resource and the Tenant 2 resource.

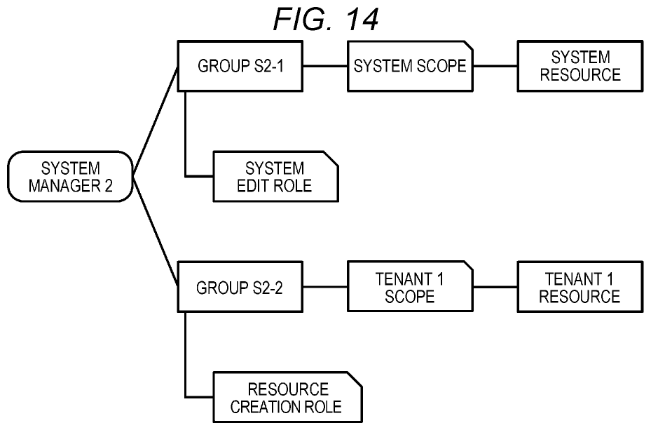

In the example of FIG. 13, the system manager 2 belongs to Group S2, and the system edit role, the resource creation role, the system scope, the Tenant 1 scope, and the Tenant 2 scope are allocated to Group S2. However, for example, as illustrated in FIG. 14, when the system edit role and the system scope is allocated to Group S2-1 and the system resource creation role and the Tenant 1 scope are allocated to Group S2-2, the system manager 2 can execute similar privilege setting even when the system manager 2 belongs to Group S2-1 and Group S2-2.

In a name space 911-2 for Tenant 1 exemplified in FIG. 13, the Tenant 1 manager is registered as a user and belongs to Group T1. The resource update role and the Tenant 1 scope are allocated to Group T1. The user belonging to Group T1 has a privilege to execute an operation defined by the resource update role on a Tenant 1 resource defined by the Tenant 1 scope. Since the Tenant 1 manager registered in the Tenant 1 name space belongs to Group T1, the Tenant 1 manager can execute an operation permitted by the resource update role on the Tenant 1 resource. For a name space 911-3 for Tenant 2 which is still another example of the name space 911, user management similar to that of the name space for Tenant 1 can be executed. When still another tenant is managed, a name space for the tenant is added and similar management is executed.

An operation permitted when the system manager 2 registered in the name space for system management accesses the Tenant 1 resource associated with the name space for Tenant 1 management which is another name space may be different from an operation permitted when the Tenant 1 manager registered in the name space for Tenant 1 management accesses the Tenant 1 resource associated with the name space for Tenant 1 management which is the name space in which the Tenant 1 manager themselves are registered. In the example of FIG. 13, the operation permitted when the system manager 2 accesses the Tenant 1 resource is an operation for which a privilege is given by the resource creation role. The operation permitted when the Tenant 1 manager accesses the Tenant 1 resource is an operation for which a privilege is given by the resource update role. Accordingly, a privilege to make access to a specific resource can be changed according to a difference in the affiliation of the user.

According to the embodiment, for example, one system manager can execute operation and access to a plurality of tenant resources including the system resource by user registration and management in the name space for the system management (without user registration and management in another name space) regarding the resource access range associated with other name spaces such as the system resource, the Tenant 1 scope, and the Tenant 2 scope. Since the system manager and the tenant manager execute management in different name spaces, constituents defined in RBAC or the like can be independently registered. Accordingly, for example, user names or the like redundant for each name space can be registered.

The configuration exemplified in FIG. 13 does not hinder combined use of the multitenant management illustrated in FIG. 7 and the multitenant management illustrated in FIG. 8. Therefore, as necessary, for example, when transitioning from the multitenant management according to the comparative example, the multitenant management according to the embodiment can be used together with the multitenant management according to the comparative example.

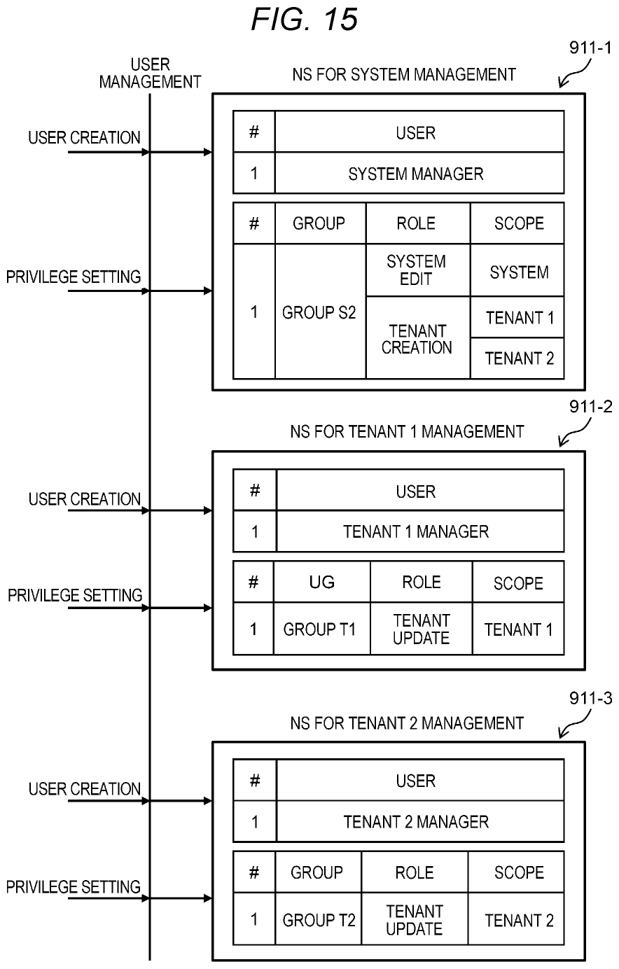

FIG. 15 illustrates an example of a flow in which user creation and privilege setting are executed in the multitenant management according to the embodiment.

In the example of FIG. 15, the system manager (a user managing a system resource and a resource associated with a tenant) and Group S to which the system manager belongs are created and registered in the name space 911-1 for system management. The Tenant 1 manager managing a resource associated with Tenant 1 and Group T1 to which the Tenant 1 manager belongs are created and registered in the name space 911-2 for Tenant 1 management. The Tenant 2 manager managing a resource associated with Tenant 2 and Group T2 to which the Tenant 2 manager belongs are created and registered in the name space 911-3 for Tenant 2 management.

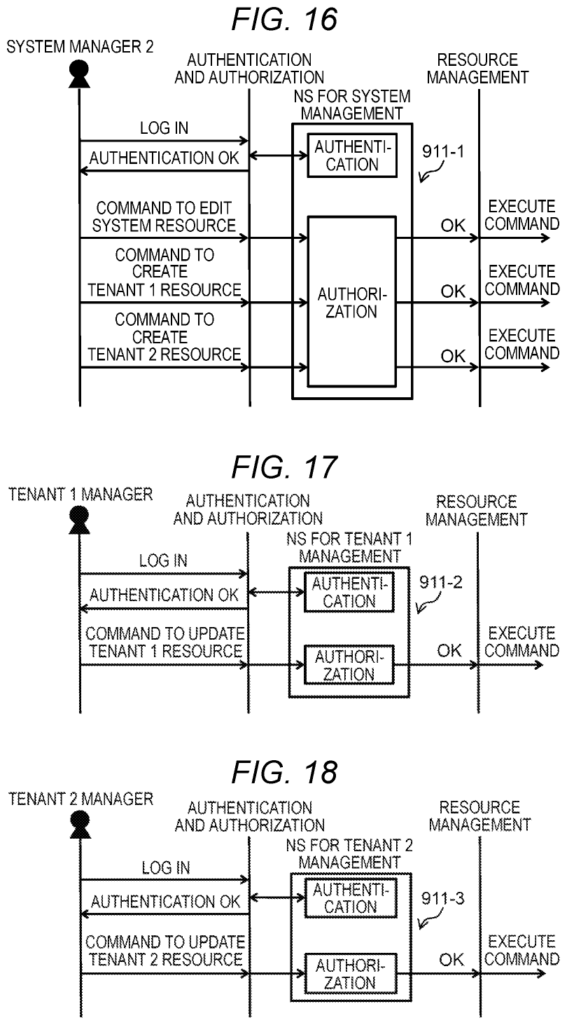

FIG. 16 illustrates an example of a flow in which authentication and authorization is executed for the system manager in multitenant management according to the embodiment.

When the system manager 2 accesses a resource and executes an operation, the system manager 2 first logs in the system (the storage system 130). The authentication platform 230 illustrated in FIG. 9 determines whether the logged-in person is a legitimate user registered in the name space 911-1 for system management. After authentication is successful (OK) for the legitimate user, the system manager 2 makes a request for executing a resource operation command.

For example, when the system manager 2 makes a request for executing a command to edit the system resource, the authorization platform 240 illustrated in FIG. 9 determines a privilege to execute the requested command based on user information and policy information set for the user. When the authorization is successful (OK), the command to edit the system resource is executed on the resource management platform 250 via the resource using application 220 illustrated in FIG. 9.

When the system manager 2 makes a request for executing a command to create a resource of Tenant 1, the authorization platform 240 illustrated in FIG. 9 determines a privilege to execute the requested command based on the user information and the policy information set for the user. When the authorization is successful (OK), the command to create a resource of Tenant 1 is executed on the resource management platform 250 via the resource using application 220 illustrated in FIG. 9.

When the system manager 2 makes a request for executing a command to create a resource of Tenant 2, the authorization platform 240 illustrated in FIG. 9 determines a privilege to execute the requested command based on the user information and the policy information set for the user. When the authorization is successful (OK), the command to create a resource of Tenant 2 is executed on the resource management platform 250 via the resource using application 220 illustrated in FIG. 9. Here, the authentication for the system manage may be executed only once.

In FIG. 16 (and FIGS. 17 and 18), a flow when results of the authentication and authorization process are not successful is omitted. When the result of the authentication or authorization process is not successful, error information may be presented to the user via the user terminal or the like so that a normal authentication and authorization procedure such as stopping the process or requesting to input information necessary for the authentication or authorization again can be executed.

FIG. 17 illustrates an example of a flow in which authentication and authorization is executed for the Tenant 1 manager in the multitenant management according to the embodiment.

When the Tenant 1 manager accesses a resource associated with Tenant 1 and executes an operation, the Tenant 1 manager first logs in the system (the storage system). The authentication platform 230 illustrated in FIG. 9 determines whether the logged-in person is a legitimate user registered in the name space for Tenant 1 management. After authentication is successful (OK) for the legitimate user, the Tenant 1 manager makes a request for executing a resource operation command. The authorization platform 240 illustrated in FIG. 9 determines a privilege to execute the requested command based on user information and policy information set for the user. When the authorization is successful (OK), the command to create the Tenant 1 resource is executed on the resource management platform 250 via the resource using application 220 illustrated in FIG. 9.

As exemplified in FIG. 18, a flow similar to the authentication and authorization flow exemplified in FIG. 17 is executed for the Tenant 2 manager.

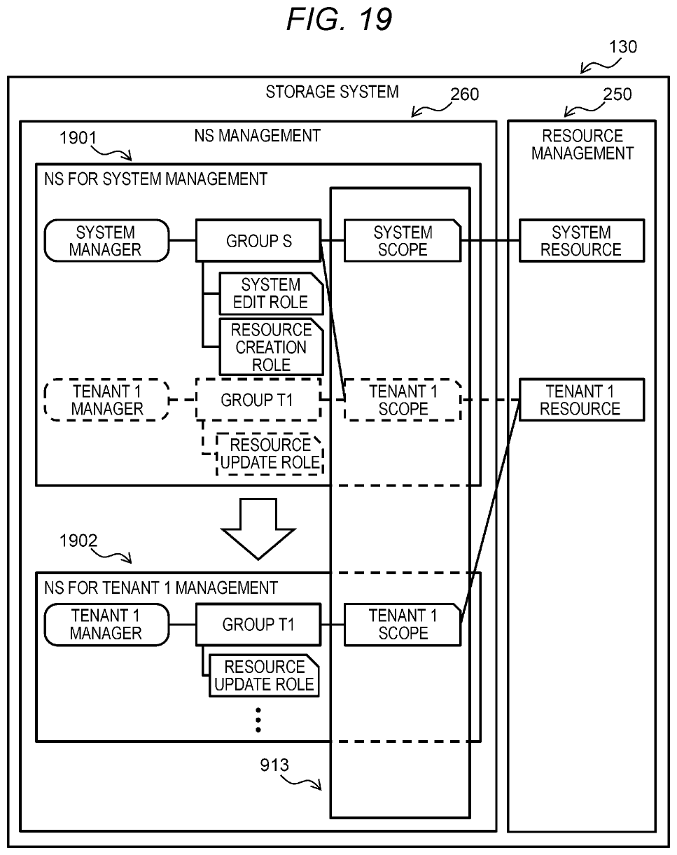

FIG. 19 illustrates an example of transitioning from the multitenant management exemplified in FIG. 8 to the multitenant management exemplified in FIG. 13.

The name space management platform 260 extracts information indicating the Tenant 1 manager, Group T1 to which the Tenant 1 manager belongs, and a role and a scope allocated to Group T1, which is information registered and managed in a name space 1901 for system management, from a user management table managed in the name space 1901 for system management, and stores the information in the user management table managed in a name space 1902 for Tenant 1 management. Here, when the name space 1902 for Tenant 1 management does not yet exist, the name space management platform 260 first creates the name space 1902 for Tenant 1 management. The Tenant 1 scope is managed across name spaces by the entire scope management table 912 and the scope management unit 913. Therefore, even when registration of the Tenant 1 manager is moved from the name space 1901 for system management to the name space 1902 for Tenant 1 management, affiliation of Group T1 of the Tenant 1 manager to Group T1 is maintained. Here, when the Tenant 1 scope is continuously allocated to Group S to which the system manager registered in the name space 1901 for system management belongs, the system manager registered in the name space 1901 for system management has a privilege to execute an access and operation to the Tenant 1 resource designated by the Tenant 1 scope.

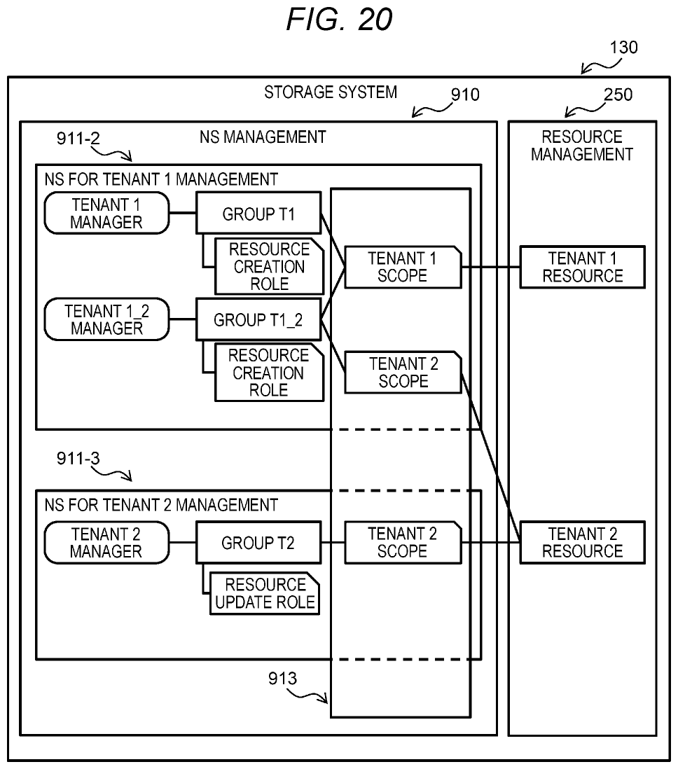

FIG. 20 illustrates another example of the multitenant management according to the embodiment.

The tenant manager can access resources associated with a plurality of tenants. In the example of FIG. 20, the resource creation role, the Tenant 1 scope, and the Tenant 2 scope is allocated to Group T1_2 registered in the name space 911-2 for Tenant 1 management. When a Tenant 1_2 manager belongs to Group T1_2, the Tenant 1_2 manager can access the Tenant 1 resource and the Tenant 2 resource. Therefore, it is necessary to register the name space for Tenant 1 management in advance as a name space where the Tenant 2 scope of the entire scope management table 912 illustrated in FIG. 10 can be designated.

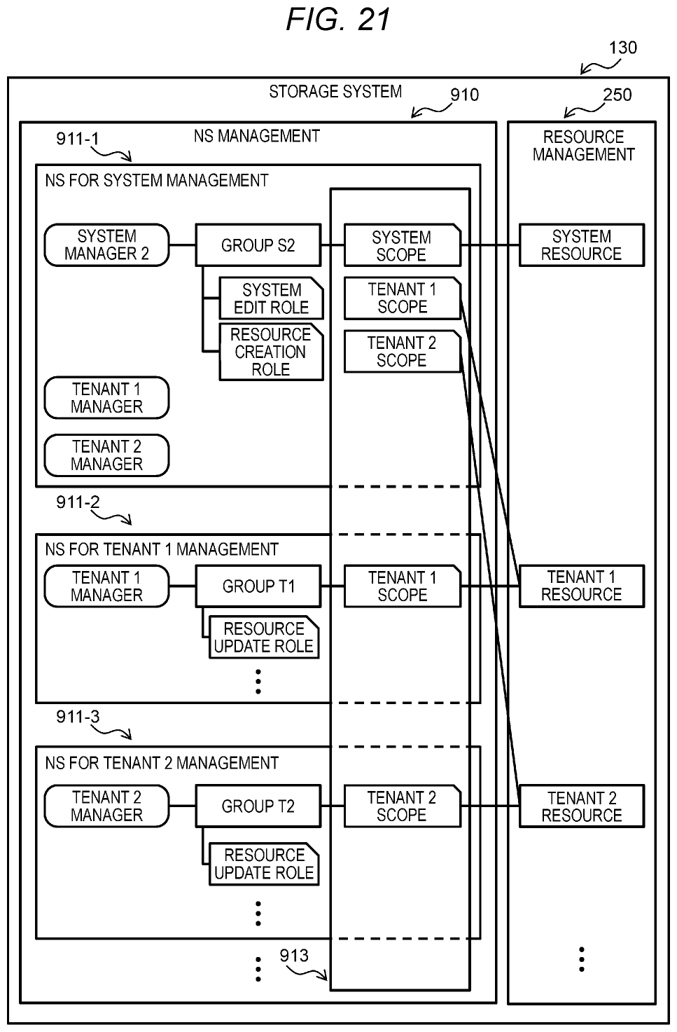

FIG. 21 illustrates still another example of the multitenant management according to the embodiment.

A user registered in different name spaces is uniquely managed in the entire multitenant management system (in the embodiment, the storage system 130). When the user is managed in the different name spaces, normally, the same user name or the like can be created and registered in the different name spaces. However, for example, when a different department is a different tenant in the same organization, duplication of the user name may be avoided in the entire system because of reasons such as desire to perform management with a unique user name in the organization. Here, when a user is registered in a name space for tenant management, for example, the name space management platform 910 first executes the user registration in a single name space such as a name space 911-1 for system management. Thereafter, the name space management platform 910 confirms whether a user to be registered is already registered in the name space 911-1 for system management and then executes the user registration for the user in a target tenant management name space. When a user to be registered is already registered in the name space 911-1 for system management, the name space management platform 910 does not permit the user registration of the user. Accordingly, users registered in all name spaces of the multitenant management system are registered in the name space 911-1 for system management, and thus the users can be managed uniquely in the multitenant management system. The same method can be used for different constituents of which unique management defined in RBAC or the like is necessary. For a user of a name space for system management who corresponds to a user registered in a name space for tenant management, a user ID and a user name may be included as user information and information such as a group, a role, and a scope is not necessary.

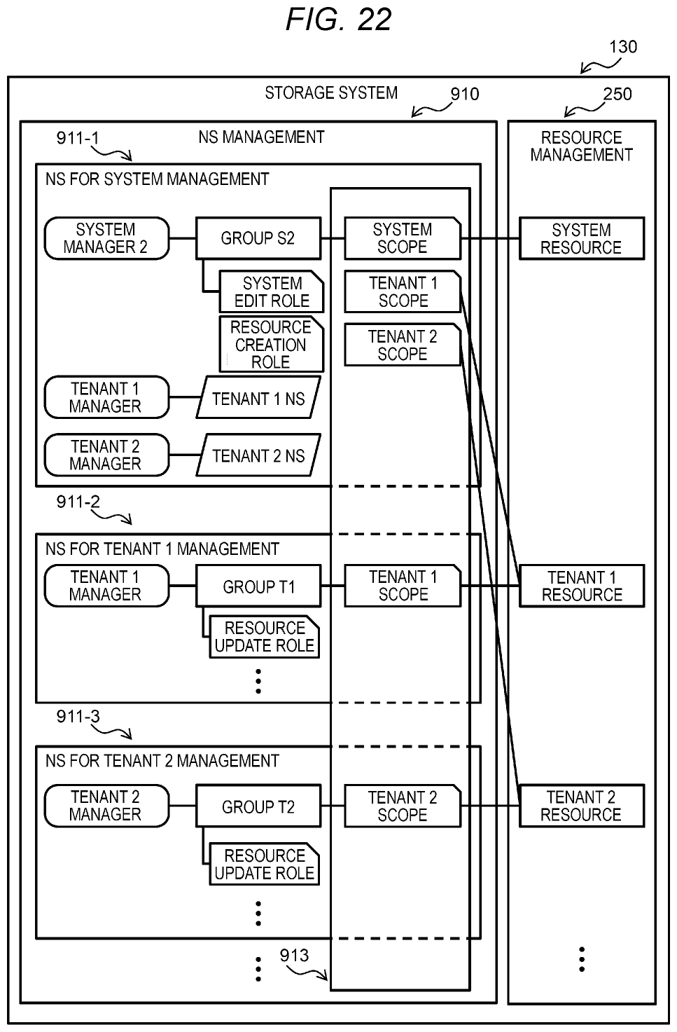

FIG. 22 illustrates still another example of the multitenant management according to the embodiment.

In an example illustrated in FIG. 22, a user corresponding to a user registered in a name space for tenant management in the name space 911-1 for system management is managed in association with information regarding a name space in which the user is registered. In the system that registers and manages users independently for each name space, when user authentication is executed and information for distinguishing in which name space a user making a request for the authentication is registered is not given, the name space management platform 910 needs to repeat an authentication operation in sequence for all name spaces located on the system until user information such as a user name, a password, or biological information of the user making the request for the authentication is matched and the authentication is successful. For example, when there are many name spaces on the system, a time necessary to execute the authentication becomes longer as a sequence of execution of the authentication has lower priority in the name space where the user making the request for the authentication is registered. Thus, there is a possibility of convenience for the user being damaged. Accordingly, information regarding the name space where the user is registered is given to the user registered in the name space for system management in association with a user registered in a name space for tenant management. The association between the user and the name space may be added to the user management table 914 illustrated in FIG. 11 or an independent table may be prepared. When the user requests the authentication, the authentication platform 230 may first execute the authentication on the name space 911-1 for system management. When compared users are registered in other name spaces for tenant management, the authentication platform 230 may extract the information regarding the name space where the user is registered based on association information of the user and the name space and execute the authentication on the extracted name spaces. Accordingly, it is possible to shorten a time related to the authentication.

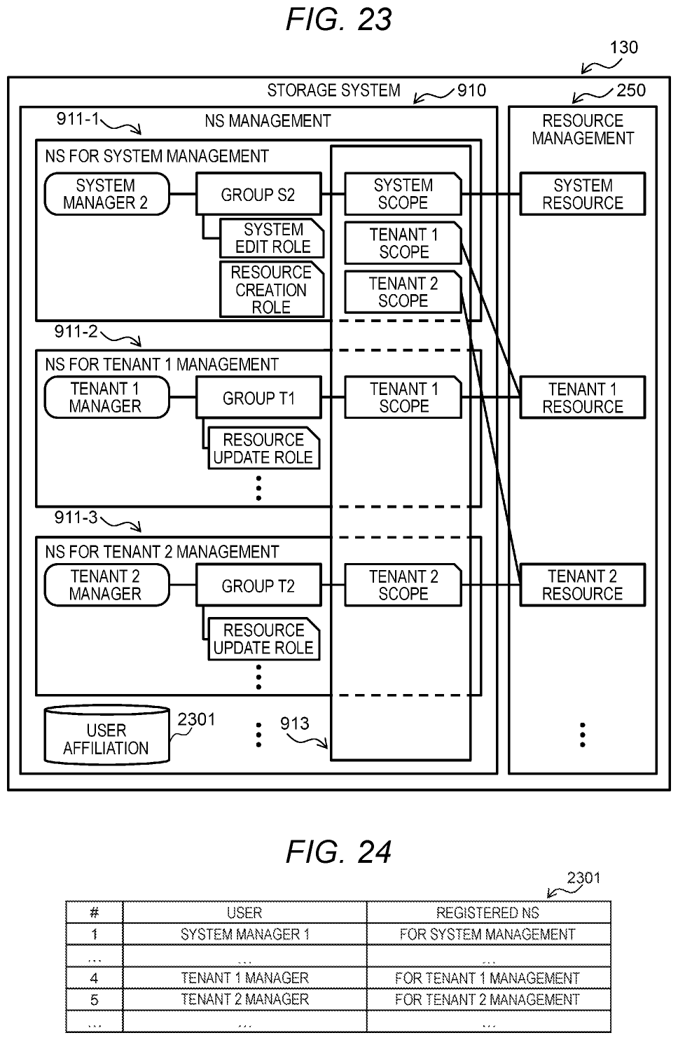

FIG. 23 illustrates still another example of the multitenant management according to the embodiment.

The name space management platform 910 retains a user affiliation table 2301 storing information for associating all users registered in all authentication target name spaces with the name space where each user is registered. When a request for a user authentication is made to the system, the name space management platform 910 first extracts the name space where the authentication target user is registered with reference to the user affiliation table 2301 and executes authentication on the name space. Accordingly, when the user authentication is executed, the name space where the user is registered can be definitely selected and it is possible to shorten a time related to the authentication.

FIG. 24 illustrates an example of the user affiliation table 2301.

In an example illustrated in FIG. 24, the system manager 1 is associated with a name space for system management. The Tenant 1 manager is associated with the name space for Tenant 1 management. For example, when the Tenant 1 manager user requests authentication, the user affiliation table 2301 is compared and a name space where the Tenant 1 manager user is registered is extracted as the name space for Tenant 1 management, and the authentication is executed on the name space for Tenant 1 management.

The present invention is not limited to the foregoing embodiments, but various modifications are included. For example, the foregoing embodiments has been described in detail to facilitate understanding of the present invention and all the described configurations may not be included. A part of a certain embodiment can be substituted with the configuration of another embodiment and the configuration of another embodiment can also be added to the configuration of a certain embodiment. Another configuration can be added to, deleted from, and/or substituted with another configuration.

Each of the foregoing configurations, functions, processing units, and the like may be implemented partially or all with hardware, for example, by designing as an integrated circuit. Each of the foregoing configurations, functions, and the like may be implemented with software by causing a processor to interpret a program implementing each function. Information regarding a program, a table, a file, and the like implementing each function can be positioned in a memory, a recording device such as a hard disk or a solid state drive (SSD), or a recording medium such as an IC card or an SD card.

Control lines or information lines are lines necessary for description and are not said to be all the control lines or information lines on a product. Actually, it may be conceivable that most of the configurations are connected to each other.

The above description can be summarized as follows. The following summary may include description of supplements and description of modifications.

The multitenant management system may be a system (for example, the storage system 130) including a plurality of resources which can be used for a plurality of tenants or may be interposed between a user and a system that includes a plurality of resources so that the multitenant management system itself does not include a plurality of resources which can be used for the plurality of tenants. In the following description, a “tenant” may be an element such as an organization or a department in an operation or may be an element that manages all of a plurality of organizations or all of a plurality of departments (that is, a “tenant” managing one or two or more “tenants”).

The multitenant management system includes an interface device (for example, the host I/F 132), a storage device (for example, the memory 136), and a processor (for example, the processor 135) connected to the interface device and the storage device. The interface device receives user information which is information regarding a user, tenant information which is information regarding a tenant, and a resource access request for designating a resource of an access destination among a plurality of resources from the user terminal 100. In the resource access request, an operation desired by a user may be designated. The storage device stores user management information (for example, the user management table 914 or 263) including the information regarding the user associated with a tenant corresponding to a name space and entire scope management information (for example, the entire scope management table 912) that is information indicating the resource access range corresponding to the tenant scope with regard to each of all tenant scopes for each of a plurality of name spaces (for example, 261 or 911) including the name space of each tenant. In each name space, the user management information includes information indicating a tenant scope that is a label of a resource access range for each of one or two or more tenants.

The processor selects a name space corresponding to a tenant indicated by the received tenant information. The processor executes authentication determination to determine whether the received user information is appropriate for information included in the user management information of the selected name space. When a result of the authentication determination is positive, the processor executes authorization determination to determine whether a resource of an access destination conforming to the received resource access request falls within a resource access range specified from the entire scope management information to correspond t scope indicated by the user management information of the selected name space. The authorization determination may include determination of whether an operation conforming to the received resource access request corresponds to an operation indicated by the user management information of the selected name space. when a result of the authorization determination is positive, the processor executes the received resource access request.

Accordingly, the user can access the resources of a plurality of tenants without authentication for each name space while independency between the tenants is guaranteed. Specifically, since the name space is an element of which separation (independency) is a purpose, the plurality of name spaces are not communized. However, the management of the tenant scopes is considered to be common between different name spaces (to be executed across different name spaces). Therefore, while maintaining the independency between the tenants, it is possible to solve troublesomeness such as authentication and authorization according for each name space (troublesomeness of authentication and authorization being necessary for each name space of each tenant when the user manages the resources of different tenants).

The plurality of name spaces may include a name space for system management (for example, the name space 911-1) serving as a name space corresponding to an unspecified tenant. One or two or more tenant scopes associated with the name space for the system management may include a system scope associated with a range of all resources. Accordingly, by authentication for the name space for another name space, the user can access any of a resource corresponding to the system scope or a resource corresponding to the tenant scope without authentication for another name space. Specifically, for example, the user management information of the name space for the system management may indicate a tenant scope for a tenant corresponding to a name space different from the name space for the system management. When the name space for the system management is selected from the received tenant information and a result of the authentication determination is positive using the user management information of the name space for the system management, the processor may specify the tenant scope for the tenant corresponding to the different name space and associated with the name space for the system management based on the resource access request in the authorization determination and may specify a resource access range corresponding to the tenant scope from the entire scope management information.

In each name space, the user management information may include information indicating one or two or more tenant scopes associated with a group for each group of users. That is, the tenant scope may be associated in units of user groups.

When information regarding a first user of a first tenant and information regarding a second user of a second tenant are included in user management information of a single name space (for example, the name space 911-2 of FIG. 20), the processor may create a name space (for example, the name space 911-3 of FIG. 20) corresponding to the second tenant and transfer the information regarding the second user of the second tenant to the user management information of the created name space. Accordingly, the management of the plurality of tenants in the single name space can be transferred to management in which independency between the tenants is guaranteed.

User management information of a certain name space (for example, the name space 911-1 of FIG. 22) among the plurality of name spaces may include information regarding one or more users registered in user management information of one or more name spaces different from the certain name space. The user management information of the certain name space may include information indicating a name space where the information regarding the user is registered with regard to each of the one or more users. The processor may specify a name space (for example, name space 911-3 for the Tenant 2 corresponding to the Tenant 2 manager) corresponding to a user indicated by the user information from the user management information of the certain name space and execute the authentication determination based on the user management information of the specified name space and the received user information (for example, the user information of the Tenant 2 manager). Accordingly, the user can expect to be authenticated for the name space where the user is registered without attempting to execute the authentication on each name space to search for the name space where the user is registered.

The storage device may store user affiliation information (for example, the user affiliation table 2301 of FIG. 24) that is information indicating a name space where a user is registered for each user. The processor may specify a name space corresponding to the user indicated by the user information from the user affiliation information and execute the authentication determination based on the user management information of the specified name space and the user information. Accordingly, the user can expect to be authenticated for the name space where the user is registered without attempting to execute the authentication on each name space to search for the name space where the user is registered.

What is claimed is:

1. A multitenant management system comprising:
an interface device configured to receive user information that is information regarding a user, tenant information that is information regarding a tenant, and a resource access request for designating a resource of an access destination among a plurality of resources from a user terminal;
a storage device configured to store user management information including information a user regarding associated with a tenant corresponding to a name space for each of a plurality of name spaces including a name space of each tenant; and
a processor connected to the interface device and the storage device, wherein
in each name space, the user management information includes information indicating a tenant scope that is a label of a resource access range for each of one or two or more tenants,
the storage device stores entire scope management information that is information indicating a resource access range corresponding to the tenant scope with regard to each of all tenant scopes, and
the processor
selects a name space corresponding to a tenant indicated by the received tenant information,
executes authentication determination to determine whether the received user information is appropriate for information included in the user management information of the selected name space,
when a result of the authentication determination is positive, executes authorization determination to determine whether a resource of an access destination conforming to the received resource access request falls within a resource access range specified from the entire scope management information to correspond to one tenant scope indicated by the user management information of the selected name space, and
when a result of the authorization determination is positive, executes the received resource access request.

2. The multitenant management system according to claim 1, wherein
the plurality of name spaces includes a name space for system management serving as a name space corresponding to an unspecified tenant, and
one or two or more tenant scopes associated with the name space for the system management include a system scope associated with a range of all resources.

3. The multitenant management system according to claim 2, wherein
the user management information of the name space for the system management indicates a tenant scope for a tenant corresponding to a name space different from the name space for the system management, and
when the name space for the system management is selected from the received tenant information and a result of the authentication determination is positive using the user management information of the name space for the system management, the processor specifies the tenant scope for the tenant corresponding to the different name space and associated with the name space for the system management based on the resource access request in the authorization determination and specifies resource access range corresponding to the tenant scope from the entire scope management information.

4. The multitenant management system according to claim 1, wherein, in each name space, the user management information includes information indicating one or two or more tenant scopes associated with a group for each group of users.

5. The multitenant management system according to claim 1, wherein the plurality of resources are resources of a storage system.

6. The multitenant management system according to claim 1, wherein
when information regarding a first user of a first tenant and information regarding a second user of a second tenant are included in user management information of a single name space, the processor
creates a name space corresponding to the second tenant, and
transfers the information regarding the second user of the second tenant to the user management information of the created name space.

7. The multitenant management system according to claim 1, wherein user management information of a certain name space among the plurality of name spaces includes information regarding one or more users registered in user management information of one or more name spaces different from the certain name space.

8. The multitenant management system according to claim 7, wherein
the user management information of the certain name space includes information indicating a name space where the information regarding the user is registered with regard to each of the one or more users, and
the processor
specifies a name space corresponding to a user indicated by the user information from the user management information of the certain name space, and
executes the authentication determination based on the user management information of the specified name space and the user information.

9. The multitenant management system according to claim 1, wherein
the storage device stores user affiliation information that is information indicating a name space where a user is registered for each user, and
the processor
specifies a name space corresponding to the user indicated by the user information, and
executes the authentication determination based on the user management information of the specified name space and the user information.

10. A multitenant management method of causing a computer:
to receive user information that is information regarding a user, tenant information that is information regarding a tenant, and a resource access request for designating a resource of an access destination among a plurality of resources from a user terminal;
to select a name space corresponding to a tenant indicated by the received tenant information; and
to execute authentication determination to determine whether the received user information is appropriate for information included in user management information of the selected name space, wherein
the user management information includes information regarding a user associated with a tenant corresponding to the name space and information indicating a tenant scope that is a label of a resource access range for each of one or two or more tenants for each of a plurality of name spaces including a name space of each tenant,
when a result of the authentication determination is positive, the computer executes authorization determination to determine whether a resource of an access destination conforming to the received resource access request falls within a resource access range specified from entire scope management information to correspond to one tenant scope indicated by the user management information of the selected name space,
the entire scope management information is information indicating a resource access range corresponding to the tenant scope with regard to each of all tenant scopes, and
when a result of the authorization determination is positive, the computer executes the received resource access request.
